(19) United States
(12) Patent Application Publication
(10) Pub. No.: US 2026/0212828 A1
(43) Pub. Date: Jul. 23, 2026

(54) Anode Reset Signal Driver Circuitry for Touch Screen Display

(71) Applicant: Apple Inc., Cupertino, CA (US)

(72) Inventors: Shinya Ono, Santa Clara, CA (US); Chin-Wei Lin, San Jose, CA (US); Dong-Gwang Ha, Santa Clara, CA (US); Hao-Lin Chiu, Los Gatos, CA (US); Hyunwoo Nho, Palo Alto, CA (US); Jiaxi Hu, San Jose, CA (US); Po-Hsuan Chang, San Diego, CA (US)

(21) Appl. No.: 19/426,943

(22) Filed: Dec. 19, 2025

Related U.S. Application Data
(60) Provisional application No. 63/748,283, filed on Jan. 22, 2025.

(51) Int. Cl. G09G 3/3266

(52) U.S. Cl. CPC G09G 3/3266; G09G 2300/0426; G09G 2300/0852; G09G 2310/0286; G09G 2310/08; G09G 2354/00

(57) ABSTRACT

An electronic device may include display and touch sensor circuitry. The display circuitry may include gate driver circuitry that provides anode reset control signals to display pixels. If desired, the gate driver circuitry may include per-row gate drivers and per-row pull-down circuits in an interlaced configuration on opposing sides of the display pixel array. If desired, the gate driver circuitry may include gate drivers configured with dynamic knee voltage control on their driver outputs.

This application claims the benefit of U.S. provisional patent application No. 63/748,283, filed Jan. 22, 2025, which is hereby incorporated by reference herein in its entirety.

### FIELD

This relates generally to electronic devices, such as electronic devices with displays.

### BACKGROUND

Electronic devices can include displays and touch sensors. For example, a touch-sensitive display in an electronic device can include display components and touch sensor components. If care is not taken, operations of display components and operations of touch sensor components can interfere with each other.

### SUMMARY

An electronic device may include a touch-sensitive (e.g., touch screen) display. The display may include an array of display pixels and gate driver circuitry coupled to the pixel array via corresponding gate lines. At least some of the gate lines may be used to provide anode reset control signals to anode reset transistors coupled to the anode terminals of light-emitting diodes of the display pixels.

In some illustrative configurations, the gate driver circuitry may include per-row gate drivers coupled to corresponding gate lines supplying the anode reset control signals. The gate driver circuitry may include per-row pull-down circuits coupled to the gate lines. The per-row gate drivers and the per-row pull-down circuits may be arranged in an interlaced configuration. In some illustrative configurations, the gate driver circuitry may include gate drivers configured to exhibit dynamic knee voltage control in the driver output signals. In particular, an adjustable voltage signal may be supplied to a transistor of each of the gate drivers to adjust the knee voltage of that driver output. Output from a dummy gate driver may be used to adjust the adjustable voltage signal.

### BRIEF DESCRIPTION OF THE DRAWINGS

FIG. 1 is a schematic diagram of an illustrative electronic device in accordance with some embodiments.

FIG. 2 is a diagram of an illustrative display having an array of display pixels in accordance with some embodiments.

FIG. 3 is a side view of illustrative layers in a touch-sensitive display in accordance with some embodiments.

FIG. 4 is a flowchart of illustrative steps for operating a touch-sensitive display in accordance with some embodiments.

FIG. 5A is a circuit diagram of an illustrative display pixel in accordance with some embodiments.

FIG. 5B is a timing diagram of illustrative signals for operating a display pixel such as the display pixel of FIG. 5A in accordance with some embodiments.

FIG. 6 is a diagram of illustrative gate driver circuitry for anode reset transistors of display pixels in accordance with some embodiments.

FIG. 7 is a circuit diagram of an illustrative gate driver for a given row of display pixels in accordance with some embodiments.

FIG. 8 is a diagram of illustrative pull-down circuits and gate driver circuits for rows of display pixels in accordance with some embodiments.

FIG. 9 is a timing diagram of illustrative signals for operating a pull-down circuit such as a given pull-down circuit of FIG. 8 in accordance with some embodiments.

FIG. 10 is a circuit diagram of an illustrative gate driver configured to receive an adjustable high gate voltage signal in accordance with some embodiments.

FIG. 11 is a timing diagram of illustrative signals for operating a gate driver such as the gate driver of FIG. 10 in accordance with some embodiments.

FIG. 12 is a diagram of illustrative gate driver circuitry including a dummy gate driver for providing dynamic knee voltage control of a gate driver such as the gate driver of FIG. 11 in accordance with some embodiments.

FIG. 13 is a circuit diagram of an illustrative gate driver configured to receive an adjustable high gate voltage signal and having shared driver output and carry output in accordance with some embodiments.

FIG. 14 is a diagram of illustrative gate driver circuitry including a dummy gate driver for providing dynamic knee voltage control of a gate driver such as the gate driver of FIG. 13 in accordance with some embodiments.

FIG. 15 is a circuit diagram of an illustrative gate driver configured to receive an adjustable low gate voltage signal and containing p-type transistors in accordance with some embodiments.

FIG. 16 is a circuit diagram of an illustrative portion of a display pixel containing a p-type anode reset transistor in accordance with some embodiments.

### DETAILED DESCRIPTION

Electronic devices may be provided with displays. Displays may be used for displaying images for users. Displays may be formed from arrays of light-emitting diode pixels or other pixels. For example, an electronic device may include an organic light-emitting diode (OLED) display. The electronic device may also include touch sensors incorporated into the display. This configuration can provide a touch-sensitive display with touch screen capabilities (e.g., enabling the detection of user touch input on the display surface).

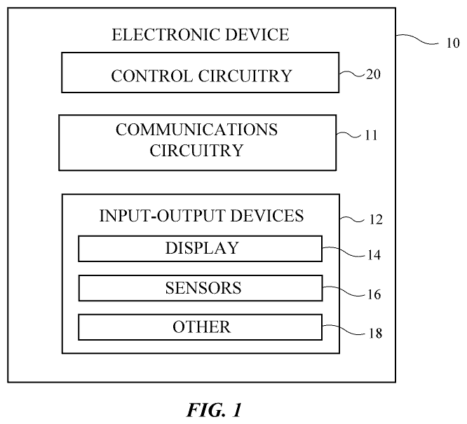

A schematic diagram of an illustrative electronic device having a display is shown in FIG. 1. Electronic device 10 may be a cellular telephone, tablet computer, laptop computer, or other portable electronic device such as a wristwatch device, head-mounted device, or other wearable device, a television, a stand-alone computer display or other monitor, a computer display with an embedded computer (e.g., a desktop computer), a system embedded in a vehicle, kiosk, or other embedded electronic device, a media player, or other electronic equipment.

Configurations in which device 10 is a wristwatch, cellular telephone, tablet computer, or other portable electronic device are sometimes described herein as an example. This example is merely illustrative. Device 10 may, in general, be any suitable electronic device with a display.

Device 10 may include control circuitry 20. Control circuitry 20 may include storage and processing circuitry for supporting the operation of device 10. The storage and processing circuitry may include storage such as non-volatile memory (e.g., flash memory, read-only memory such as electrically-programmable-read-only memory, solid-state drives, hard disk drives, and/or other types of non-volatile memory), volatile memory (e.g., static and/or dynamic random-access-memory), etc. Processing circuitry in control circuitry 20 may be used to gather input from sensors and other input devices and may be used to control output devices. The processing circuitry may be based on (e.g., include) one or more microprocessors, application processors, microcontrollers, digital signal processors, baseband processors and other wireless communications circuits, power management units, audio chips, application specific integrated circuits, etc. In some illustrative configurations, at least a portion of the processing circuitry of circuitry 20 may sometimes be referred to as an application processor or a system processor. During operation, control circuitry 20 may use a display and other output devices in providing a user with visual output and other output.

To support communications between device 10 and external equipment, control circuitry 20 may communicate using communications circuitry 11. Circuitry 11 may include antennas, wireless transceiver circuitry (e.g., radio-frequency transceiver circuitry), and other wireless communications circuitry and/or wired communications circuitry. If desired, some portion(s) of circuitry 11 may be formed as part of (e.g., is integrated with) control circuitry 20 and may sometimes be referred to as control and communications circuitry.

In some illustrative configurations, (wireless) communications circuitry 11 may support bidirectional wireless communications between device 10 and external equipment over wireless link(s). For example, circuitry 11 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, and/or transceiver circuitry configured to support communications over any other suitable wired or wireless communications link. Wireless communications may, for example, be supported over a Bluetooth® link, a WiFi® link, a wireless link operating at a frequency between 6 GHz and 300 GHz, a 60 GHz link or other millimeter wave link, a cellular network link, a wireless local area network link, a personal area network communications link, and/or other types of wireless communications links. Device 10 may, if desired, include power circuits for transmitting and/or receiving wired and/or wireless power and may include batteries or other energy storage devices. For example, device 10 may include a coil and rectifier circuitry to receive wireless power that is used to power circuitry in device 10.

Device 10 may include input-output devices such as input-output devices 12. Input-output devices 12 may be used in gathering user input, in gathering information on the environment surrounding the user, and/or in providing user(s) with output. Devices 12 may include one or more displays such as display 14. Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), or another type of display. Configurations in which display 14 is an organic light-emitting diode display are sometimes described herein as an example.

Sensors 16 in input-output devices 12 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and/or other sensors. Display 14 with overlapping touch sensor circuitry that provide touch sensing functionality may sometimes be referred to as a touch screen display or a touch-sensitive display. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In some arrangements, device 10 may use sensors 16 and/or other input-output devices to gather user input. For example, buttons may be used to gather button press input, touch sensors overlapping displays can be used for gathering user touch input (e.g., received at the touch screen surface), touch pads may be used in gathering touch input, microphones may be used for gathering audio input, etc.

If desired, electronic device 10 may include additional components such as other devices 18 of input-output devices 12. The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

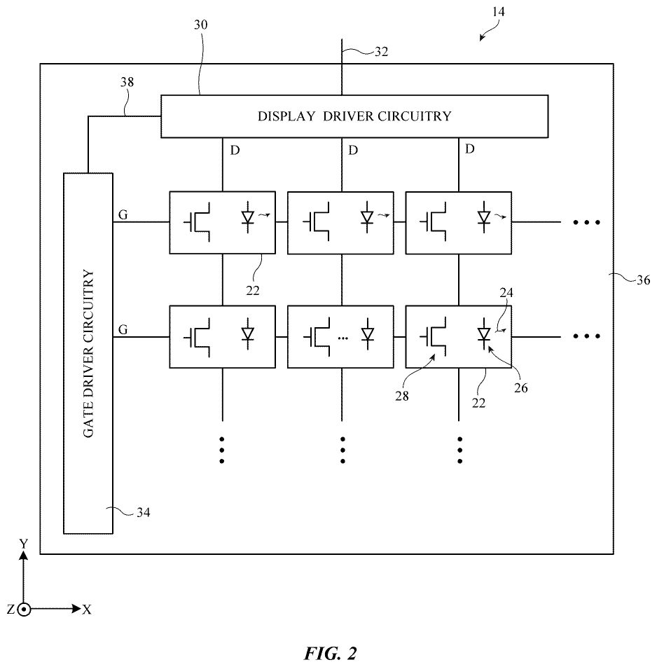

FIG. 2 is a schematic diagram of display 14 (e.g., in a top plan view). As examples, display 14 may have a rectangular shape (e.g., have a rectangular footprint with lateral edges that run around a rectangular periphery) or may have other suitable shapes. Display 14 may provide a planar display surface (at which images are displayed), and if desired, may also provide curved display surface(s).

As shown in FIG. 2, display 14 may have an array of display pixels 22 (sometimes referred to as pixels 22) formed on a substrate 36. Substrate 36 may be formed from glass, metal, plastic, ceramic, porcelain, and/or other substrate materials. Pixels 22 may receive data signals over signal paths such as data lines D (sometimes referred to as data signal lines or column lines) and may receive one or more control signals over control signal paths such as horizontal control lines G (e.g., including gate lines, scan lines, emission lines, row lines, etc.). There may be any suitable number of rows and columns of pixels 22 in display 14 (e.g., tens or more, hundreds or more, or thousands or more).

Each display pixel 22 may have a light-emitting diode 26 that emits light 24 under the control of a pixel control circuit formed from thin-film transistor circuitry such as thin-film transistors 28 and thin-film capacitors). Thin-film transistors 28 may include polysilicon thin-film transistors, semiconducting oxide thin-film transistors such as indium zinc gallium oxide transistors, and/or thin-film transistors formed from other semiconductors. Pixels 22 may contain light-emitting diodes of different colors (e.g., red, green, and blue) to provide display 14 with the ability to display color images.

Display 14 may include display driver circuitry 30 communicatively coupled to and used to control the operation of pixels 22. Display driver circuitry 30 may be formed from integrated circuits, thin-film transistor circuits, or other suitable circuitry. Display driver circuitry 30 may include communications circuitry for communicating with system control circuitry such as control circuitry 16 of FIG. 1 over path 32. Path 32 may be formed from traces on a flexible printed circuit or other cable. During operation, the control circuitry of device 10 (e.g., control circuitry 16 of FIG. 1) may supply display driver circuitry 30 with information on images to be displayed on display 14.

To display the images on pixels 22, display driver circuitry 30 may supply image data to data lines D (e.g., data lines that run down the columns of pixels 22) while issuing clock signals and other control signals to support other display driver circuitry such as gate driver circuitry 34 over path(s) 38. If desired, display driver circuitry 30 may also supply clock signals and other control signals to additional gate driver circuitry on an edge of display 14 opposite the edge along which gate driver circuitry 34 is provided. In other words, gate driver circuitry may be provided on two or more sides of the array of pixels 22.

Gate driver circuitry 34 (sometimes referred to as horizontal line control circuitry, row driver circuitry, or display driver circuitry) may be implemented as part of an integrated circuit and/or may be implemented using thin-film transistor circuitry. Horizontal/row control lines G in display 14 may carry gate line signals (scan line control signals), emission enable control signals, and/or other horizontal control signals for controlling the pixels of each row. There may be any suitable number of horizontal control signals per row of pixels 22 (e.g., conveyed on one or more row control lines, two or more row control lines, three or more row control lines, four or more row control lines, five or more row control lines, etc.).

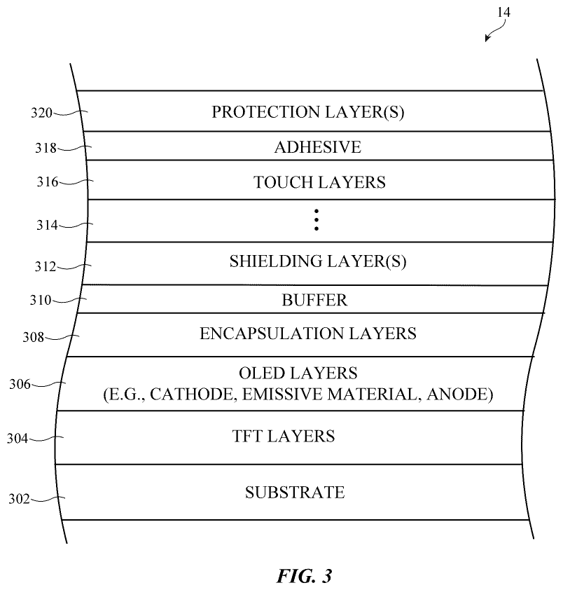

FIG. 3 is a cross-sectional side view of a touch-sensitive display, sometimes referred to as a touch screen display (e.g., display 14 with overlapping touch sensor circuitry). As shown in FIG. 3, display 14 may include substrate 302 (e.g., forming a portion of or included as part of substrate 36 in FIG. 2). Substrate 302 may be formed from glass, metal, plastic, ceramic, sapphire, and/or other suitable substrate materials. As examples, substrate 302 may be an organic substrate formed from polyimide (PI), polyethylene terephthalate (PET), or polyethylene naphthalate (PEN). The surface of substrate 302 may optionally be covered with one or more buffer layers (e.g., inorganic buffer layers such as layers of silicon oxide, silicon nitride, etc.).

Thin-film transistor (TFT) layers 304 may be formed over substrate 302. TFT layers 304 may include thin-film transistor circuitry such as thin-film transistors (e.g., silicon transistors, semiconducting oxide transistors, etc.), thin-film capacitors, associated routing circuitry, and other thin-film structures formed within multiple metal routing layers and dielectric layers. Thin-film transistor circuitry in layer 304 may form transistors 28, capacitors, and/or other pixel components in pixels 22 of FIG. 2. Organic light-emitting diode (OLED) layers 306 may be formed over TFT layers 304. OLED layers 306 may include a cathode layer, an anode layer, and emissive material interposed between the cathode and anode layers. The cathode layer may be formed above the anode layer. The cathode layer may be biased to a ground power supply voltage ELVSS. Ground power supply voltage ELVSS may be 0 V, −2 V, 4, −6V, less than −8V, −10V, −12V, or any suitable ground or negative power supply voltage level. If desired, the cathode layer may be formed under the anode layer. Light-emitting diodes in layer 306 may form light-emitting diodes 26 in pixels 22 of FIG. 2.

Circuitry formed in TFT layers 304 and OLED layers 306 may be protected by encapsulation layers 308. As an example, encapsulation layers 308 may include a first inorganic encapsulation layer, an organic encapsulation layer formed on the first inorganic encapsulation layer, and a second inorganic encapsulation layer formed on the organic encapsulation layer. Encapsulation layers 308 formed in this way can help prevent moisture and other potential contaminants from damaging circuitry covered by layers 308. This is merely illustrative. Encapsulation layers 308 may include any number of inorganic and/or organic barrier layers formed over the OLED layers 306. One or more buffer layers such as layer 310 may be formed on encapsulation layers 308. Buffer layer 310 may be formed from silicon oxide, silicon nitride, or other suitable buffering materials.

One or more touch (sensor) layers 316 that implement the touch sensor functions of touch-sensitive display 14 may be formed over the display layers (e.g., over layers 306, 304, etc.). For example, touch sensor layers 316 may include touch sensor circuitry such as horizontal touch sensor electrodes and vertical touch sensor electrodes collectively forming an array of capacitive touch sensor electrodes. One or more protection layers 320 such as cover layer(s) (e.g., a cover glass) may be formed over touch sensor layers 316 and may be attached to other layers of display 14 (e.g., touch layers 316) using adhesive 318 (e.g., optically clear adhesive material). The layer(s) 320 may serve as an outer protective layer for display 14.

In certain applications, noise from the display circuitry (e.g., the circuitry in layers 304 and 306) can leak or be inadvertently coupled to the touch sensor circuitry (e.g., the circuitry in layers 316). For example, power supply noise on the upper cathode layer can sometimes be inadvertently coupled to the touch sensor circuitry. Such display noise can potentially degrade the accuracy and performance of the touch sensor circuitry. Display noise may be particularly problematic at higher refresh rates (e.g., refresh rates of greater than 60 Hz, greater than 80 Hz, greater than 100 Hz, 120 Hz or greater, etc.). Accordingly, if desired, one or more shielding layers such as shielding layer(s) 312 may be provided between the display circuitry and the touch sensor circuitry. As shown in FIG. 3, a shielding layer 312 may be formed on buffer layer 310 above encapsulation layers 308. Buffer layer 310 may sometimes be considered to be part of shielding layers 312. Shielding layer 312 may be implemented as a conductive mesh structure, a transparent conductive film, a conductive mesh structure overlapped by a transparent conductive film, or another structure in an electrical shielding configuration. The presence of shielding layer 312 reduces the capacitive coupling between display circuitry and touch sensor circuitry, and thus helps to mitigate the effect of display noise on the touch sensor structures. Shielding layer 312 (sometimes referred to as a noise shielding layer) may be actively driven using noise cancellation signals or passively driven using a direct current (DC) power supply voltage source.

If desired, one or more additional layers 314 may be disposed between shielding layer 312 and touch sensor layers 316. Layer(s) 314 may include one or more polarizer films, optically clear adhesive films, and/or other suitable layers in a touch screen display. If desired, display 14 may include other layers at suitable locations in the touch-sensitive display layers of FIG. 3.

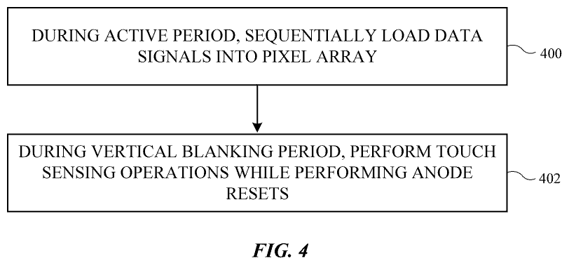

FIG. 4 is a flowchart of illustrative steps for operating a touch-sensitive display such as display 14 of device 10. During the operations of block 400, display driver circuitry 30 and gate driver circuitry 34 may sequentially load data signals into the array of pixels (e.g., pixels 22 of FIG. 2) during an active period. During the active period, the display pixels can be refreshed with newly loaded data signals while also performing anode reset operations (e.g., for resetting an anode terminal of light-emitting diode 26 in each pixel 22). In other words, the active period includes a plurality of data refresh periods. During the active period, the diodes 26 in display pixels 22 can also be configured to emit light during a period sometimes referred to as an “active” emission or emission “on” period.

During the operations of block 402, the display circuitry can be configured with (e.g., to exhibit) a vertical blanking period. Touch sensing operations can be performed during the vertical blanking period. In some illustrative configurations, display 14 may perform anode reset operations during the vertical blanking period while the touch sensing operations are being performed (e.g., one or more anode reset transistors can be activated while the touch sensor circuitry is performing touch sensing operations). During the vertical blanking period, the diodes 26 in pixels 22 do not emit light. This time during which the diodes 26 are inactive is thus sometimes referred to as an “inactive” emission or emission “off” period. Such operation might be employed for displays operating at higher refresh rates (e.g., refresh rates that are greater than 60 Hz, equal to or greater than 90 Hz, equal to or greater than 100 Hz, equal to or greater than 120 Hz, etc.). Performing anode reset operations while the touch sensing operations are being performed can, if care is not taken, inject display noise into the touch sensor circuitry.

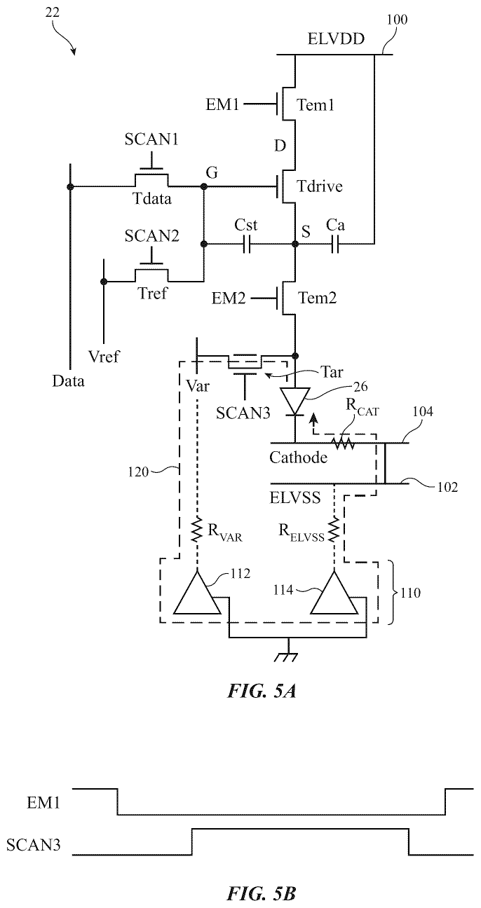

Pixels 22 of display 14 may be configured in any suitable manner (e.g., may include any suitable number of transistors, capacitors, light-emitting diodes, and/or other components communicatively coupled to and arranged relative to one another in any suitable manner). FIG. 5A is a circuit diagram showing an illustrative configuration of display pixel 22 (e.g., used to form each pixel 22 of the pixel array of display 14 in FIG. 2). The illustrative pixel configuration of FIG. 5A is merely illustrative. Other types of pixels may be used to implement pixels 22 of display 14 in FIG. 2.

As shown in the example of FIG. 5A, pixel 22 may include a light-emitting element such as an organic light-emitting diode 26, a capacitor such as storage capacitor Cst, an additional capacitor such as capacitor Ca, and thin-film transistors such a drive transistor Tdrive, a gate-voltage-setting transistor Tref, a data loading transistor Tdata, an anode reset transistor Tar, and emission control transistors Tem1 and Tem2. Transistors Tdrive, Tdata, Tref, Tar, Tem1, and Tem2 may each be implemented as an n-type transistor (e.g., a semiconducting oxide transistor or an n-channel silicon transistor) or as a p-type transistors (e.g., a p-channel silicon transistor). If desired, pixel 22 may include additional initialization transistors for applying an initialization or reference voltage to one or more internal nodes within pixel 22. If desired, display pixel 22 may further include additional switching or biasing transistors for applying one or more bias voltages for improving the performance or operation of pixel 22.

At least some or all of the transistors within pixel 22 can be implemented as semiconducting oxide transistors. “Semiconducting oxide” transistors can refer to and be defined herein as thin-film transistors having a channel region formed from semiconducting oxide material (e.g., indium gallium zinc oxide or IGZO, indium tin zinc oxide or ITZO, indium gallium tin zinc oxide or IGTZO, indium tin oxide or ITO, or other semiconducting oxide material) and are generally considered n-type (n-channel) transistors. A semiconducting oxide transistor is notably different from a “silicon” transistor (e.g., a transistor having a polysilicon channel region deposited using a low temperature process sometimes referred to as LTPS or low-temperature polysilicon). Semiconducting oxide transistors exhibit lower leakage than silicon transistors, so implementing at least some of the transistors within pixel 22 can help reduce flicker (e.g., by preventing current from leaking away from the gate terminal of drive transistor Tdrive). If desired, at least some of the transistors within pixel 22 may be implemented as silicon transistors such that pixel 22 has a hybrid configuration that includes a combination of semiconducting oxide transistors and silicon transistors (e.g., n-type LTPS transistors or p-type LTPS transistors).

In particular, drive transistor Tdrive has a gate terminal G, a drain terminal D, and a source terminal S. The terms “source” and “drain” are sometimes used interchangeably when referring to current-conducting terminals of a transistor. The source and drain terminals are therefore sometimes referred to as “source-drain” terminals (e.g., a transistor has a gate terminal, a first source-drain terminal, and a second source-drain terminal). The term “activate” with respect to a switch (or transistor) may refer to or be defined herein as an action that places the switch in an “on” or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch (or transistor) are electrically disconnected with minimal leakage current. Deactivating a switch can sometimes be referred to as turning off or opening a switch.

Transistor Tdrive, emission transistors Tem1 and Tem2, and light-emitting diode 26 are coupled in series between positive power supply line 100 (e.g., a power supply terminal) on which positive power supply voltage ELVDD is provided and ground power supply line 102 (e.g., a ground terminal) on which ground power supply voltage ELVSS is provided. Positive power supply voltage ELVDD may be 3 V, 4 V, 5 V, 6 V, 7 V, 2 to 8 V, greater than 6 V, greater than 8 V, greater than 10 V, greater than 12 V, 6-12 V, 12-20 V, or any suitable positive power supply voltage level. Ground power supply voltage ELVSS may be 0 V, −1 V, −2 V, −3 V, −4 V, −5V, −6 V, −7 V, less than 2 V, less than 1 V, less than 0 V, or any suitable ground or negative power supply voltage level.

Emission transistor Tem1 may have a gate terminal configured to receive first emission control signal EM1, whereas transistor Tem2 has a gate terminal configured to receive a second emission control signal EM2. This example in which emission transistors Tem1 and Tem2 receive different emission (control) signals is merely illustrative. In other embodiments, transistors Tem1 and Tem2 can receive the same emission control signal. During an emission phase (e.g., time period), signals EM1 and EM2 can be asserted to turn on emission transistors Tem1 and Tem2, which allows current to flow from drive transistor Tdrive to diode 26. The degree to which drive transistor Tdrive is activated controls the amount of current flowing from terminal 100 to terminal 102 through diode 26 and therefore an amount of emitted light from display pixel 22.

Storage capacitor Cst may be coupled between the gate and source terminals of drive transistor Tdrive. Data loading transistor Tdata may have a first source-drain terminal coupled to the gate terminal of transistor Tdrive, a second source-drain terminal coupled to a data line (e.g., a column line carrying the Data signal), and a gate terminal configured to receive a first scan control signal SCAN1. Transistor Tref may have a first source-drain terminal coupled to the gate terminal of transistor Tdrive, a second source-drain terminal coupled to a reference voltage Vref via a reference voltage line (e.g., a column line carrying reference voltage Vref), and a gate terminal configured to receive a second scan control signal SCAN2. Transistor Tref that is operable to pass reference voltage Vref onto the gate terminal of transistor Tdrive may therefore sometimes be referred to as a gate-voltage-setting transistor or a reference transistor. Voltage Vref may be a fixed voltage level that is equal to voltage ELVDD, less than voltage ELVDD, or some other voltage level between voltage ELVSS and voltage ELVDD.

Capacitor Ca may be coupled between the source terminal of transistor Tdrive and positive power supply line 100. Configured in this way, capacitor Ca can serve to boost the drive current levels of pixel 22 and is therefore sometimes referred to as a current boosting capacitor. The connection of capacitor Ca to power supply line 100 is merely illustrative. If desired, capacitor Ca may instead be coupled to a terminal that provides voltage ELVSS, voltage Vref, voltage Var, or other available/existing DC or static supply voltage within pixel 22.

Anode reset transistor Tar may have a first source-drain terminal coupled to the anode terminal of diode 26 (sometimes referred to as the anode electrode), a second source-drain terminal configured to receive an anode reset voltage via an anode reset voltage line (e.g., a column line carrying anode reset voltage Var), and a gate terminal configured to receive a third scan control signal SCAN3. Diode 26 has a cathode terminal (sometimes referred to as the cathode electrode) coupled to ground power supply line 102 (sometimes referred to as a common power supply line).

The anode reset voltage Var can be driven by an associated anode reset voltage driver 112. The anode reset voltage line on which voltage Var is provided can have an associated path resistance R_{VAR}. The ELVSS ground voltage can be driven by an associated ground voltage driver 114. The ground voltage line on which ELVSS is provided can have an associated ground path resistance R_{ELVSS}. Voltage drivers 112 and 114 can be implemented as part of a power management circuit 110 separate from the array of pixels 22. In the example of FIG. 5A, ground power supply line 102 can be coupled to cathode terminal 104 of diode 26 through a conductive via structure (e.g., a laser drilling contact having an associated resistance that may contribute to ground path resistance R_{ELVSS}). The cathode terminal 104 of one or more pixels 22 can be implemented as a cathode layer that overlaps and is shared by pixel(s) 22 and that has an associated cathode resistance R_{CAT}.

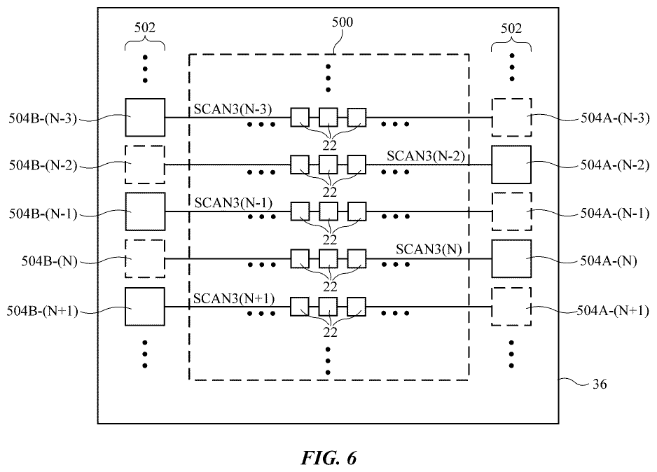

In practice, the anode terminal of diode 26 can have an anode voltage that is dependent on the current brightness level of diode 26 (e.g., the anode voltage level is brightness or content dependent). For example, a higher gray level can lead to a higher anode voltage, whereas a lower gray level can lead to a lower anode voltage. During an anode reset operation, current can flow through anode reset transistor Tar and diode 26, as indicated by anode reset current path 120 (see dotted current path in FIG. 5A). The anode reset current path 120 can also sometimes be referred to herein as the anode “discharge” path. Depending on the voltage level present at the anode terminal of diode 26 at the beginning of the anode reset operation, the amount of current 120 flowing into the cathode terminal 104 can vary. The cathode can be electrically coupled to one or more touch sensor electrodes of the touch sensor circuitry. This can cause a varying amount of cathode rippling when an anode reset operation is performed during the vertical blanking period (e.g., described in connection with FIG. 4). Such image/content dependent cathode rippling can inadvertently be coupled onto and perceived by the touch sensor circuitry, resulting in undesired interference between the display and touch sensor components. Various techniques for mitigating (e.g., reducing) this type of undesired interference are further described herein (e.g., in connection with FIGS. 6-14).

FIG. 5B is a timing diagram showing illustrative signals for operating display pixel(s) 22 of display 14, such as pixel(s) 22 when each implemented in the configuration shown in FIG. 5A, during the vertical blanking period (e.g., described in connection with FIG. 4). As shown in FIG. 5B, signal EM1 can be pulsed low during the vertical blanking period. Driving signal EM1 low in this way deactivates transistor Tem1, which prevents emission current from flowing through diode 26. As a result, no light is emitted from pixel 22 during this time. The period during which signal EM1 is pulsed low is thus sometimes referred to as an emission “off” period. While signal EM1 is pulsed low, signal SCAN3 may be pulsed high to activate anode reset transistor Tar. The high pulse width of signal SCAN3 may be less than the low pulse width of signal EM1 (e.g., signal SCAN3 may be driven high sometime after the falling edge of signal EM1 and driven low before the next rising edge of signal EM1). If desired, the waveforms of FIG. 5B can thus be adopted to perform multiple anode reset operations during the vertical blanking period (e.g., multiple separate anode reset pulses can be employed while the touch sensor circuitry is activated, if desired).

As described above in connection with FIG. 5A, during an anode reset operation, an anode reset discharge current can flow through the cathode terminal of diode 26. Since the cathode layer can be capacitively coupled to the touch sensor electrodes, reducing the current spike of the discharge current during the anode reset operation can help reduce the cathode voltage rippling, which will reduce the amount of noise interference between the display circuitry and the touch sensor circuitry.

The configuration of gate driver circuitry for scan signals SCAN3 across different pixel rows will impact the overall amount of anode reset discharge current (e.g., the level of current spike at a given time) introduced on the cathode layer of diode(s) 26 of pixel(s) 22. Consider a scenario in which a gate driver formed on one side of the pixel array (e.g., in gate driver circuitry 34 in FIG. 2) is configured to output a scan signal SCAN3 that is provided to at least two different rows of pixels in the pixel array. When this scan signal SCAN3 is used to activate the anode reset transistors Tar of pixels 22 of multiple rows, an undesirable level of overall anode reset discharge current may be introduced at the same time (e.g., because each pixel 22 of the two rows will cumulatively contribute to the overall anode reset discharge current), thereby leading to increased cathode voltage rippling and noise impact on the capacitively coupled touch sensor circuitry.

Accordingly, to improve coexistence of display circuitry and touch sensor circuitry (e.g., reduce interference therebetween) gate driver circuitry may be configured to output an (anode reset control) signal SCAN3 for each row of pixels 22. FIG. 6 is a diagram of illustrative gate driver circuitry (e.g., implementing the gate driver circuitry described in connection with FIG. 2) configured in this manner. In particular, as shown in FIG. 6, gate driver circuitry 502 (e.g., a portion of driver circuitry 34 in FIG. 2) may provide an anode reset control signal SCAN3(N) for row N of pixels 22, may provide an anode reset control signal SCAN3(N-1) for row (N−1) of pixels 22, may provide an anode reset control signal SCAN3(N-2) for row (N−2) of pixels 22, may provide an anode reset control signal SCAN3(N−3) for row (N−3) of pixels 22, etc., may provide an anode reset control signal SCAN3(N+1) for row (N+1) of pixels 22, may provide an anode reset control signal SCAN3(N+2) for row (N+2) of pixels 22, etc. Each anode reset control signal SCAN3 (e.g., signal SCAN(N), SCAN(N−1), etc., SCAN(N+1), etc.) may be conveyed on a respective row line (e.g., line G in FIG. 2) to activate and deactivate anode reset transistors Tar of pixels 22 of the corresponding row.

Gate driver circuitry 502 may include circuitry formed on opposite (e.g., left and right) sides of active area 500 (e.g., an area that overlaps the array of active pixels 22 for displaying images for display 14). In particular, in order to reduce border area (e.g., the left border width from the left edge of active area 500 to the left edge of substrate 36, the right border width from the right edge of active area 500 to the right edge of substrate 36, etc.), gate drivers for gate driver circuitry 502 may be provided in an interlaced configuration on opposing sides of active area 500 (e.g., along the left and right edges of substrate 36).

More specifically, first gate drivers may be provided along a first side of active area 500 to supply even rows of pixels 22 with corresponding control signals SCAN3, while second gate drivers may be provided along a second (opposite) side of active area 500 to supply odd rows of pixels 22 with corresponding control signals SCAN3. In the example of FIG. 6, the first gate drivers may be gate drivers 504A on the right side of active area 500 such as driver 504A-(N) for row N (e.g., an even row), driver 504A-(N−2) for row (N−2), driver 504A-(N−4) for row (N−4), etc., and similarly, driver 504A-(N+2) for row (N+2), driver 504A-(N+4) for row (N+4), etc. The second gate drivers may be gate drivers 504B on the left side of active area 500 such as driver 504B-(N−1) for row (N−1) (e.g., an odd row), driver 504B-(N−3) for row (N−3), etc., and similarly, driver 504B-(N+1) for row (N+1), driver 504B-(N+3) for row (N+3), etc.

While gate driver circuitry 502 in the interlaced configuration may provide narrower display border widths and may facilitate anode reset operations of pixels 22 in the different rows in a manner that reduces the overall anode reset discharge current (e.g., relative to when the same signal SCAN 3 is provided to multiple rows of pixels 22, as described above), display luminance may be adversely affected. In particular, patterned noise (e.g., undesired variation) in luminance may be introduced due to differences between odd and even pixel rows receiving anode reset control signals exhibiting different falling edge characteristics (e.g., falling time speed) depending on the (left or right) side of the provided gated driver.

Although these issues may be resolved when gate driver circuitry 502 is configured to include symmetric drivers for each row (e.g., drivers 504A for anode reset control signals are provided for a first half of pixels of all rows and drivers 504B for anode reset control signals are provided for a second half of pixels of all rows), this configuration (e.g., in which drivers 504A-(N−1), 504A-(N−3), etc., 504A-(N+1), etc., and drivers 504B-(N), 504B-(N−2), etc., 504B-(N+2), etc., are additionally included) may undesirably widen the display border widths (e.g., the right and left border widths).

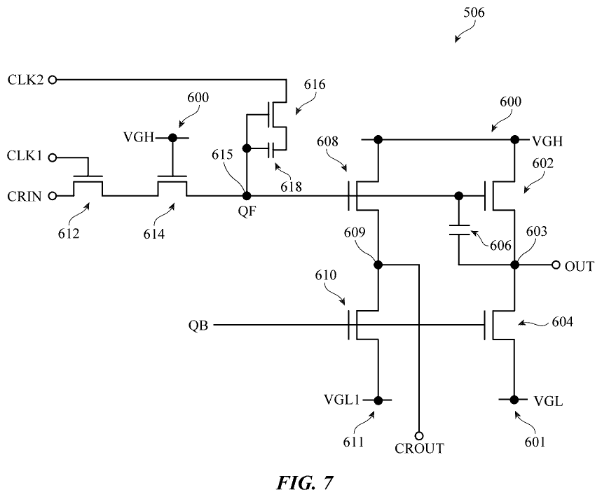

Accordingly, to mitigate the above-mentioned issues with luminance uniformity while providing relatively narrow border widths, gate driver circuitry 502 may be provided with gate drivers supplemented with pull-down circuits, each for a corresponding row of pixels 22. This illustrative configuration is further detailed in connection with FIG. 7.

FIG. 7 is a circuit diagram of an illustrative gate driver (e.g., gate driver 506) usable to implement each instance of drivers 504A and/or 504B in gate driver circuitry 502 in FIG. 6. As shown in FIG. 7, gate driver 506 may include transistor 602 and transistor 604 coupled in series between a first (high) power supply (voltage) line 600 (e.g., a supply voltage terminal) supplying high gate voltage VGH and a second (low) power supply (voltage) line 601 (e.g., a supply voltage terminal) supplying low gate voltage VGL (less than voltage VGH). Transistor 602 may have a first source-drain terminal coupled to line 600, a second source-drain terminal coupled to driver output node (or terminal) 603, and a gate terminal coupled to node 615 and configured to receive signal QF. Driver 506 may include capacitor 606 having a first terminal coupled to the gate terminal of transistor 602 and a second terminal coupled to node 603 (e.g., to the second source-drain terminal of transistor 602). Transistor 604 may have a first source-drain terminal coupled to driver output node 603, a second source-drain terminal coupled to line 601, and a gate terminal configured to receive signal QB. The driver output signal OUT, which is SCAN3 when driver 506 implements an anode reset control signal driver, may be provided from node 603 to any transistors Tar of pixels 22 coupled to driver 506.

Driver 506 may include transistor 608 and transistor 610 coupled in series between first power supply voltage line 600 supplying high gate voltage VGH and (additional) power supply voltage line 611 (e.g., a supply voltage terminal) supplying (additional) low gate voltage VGL1 (e.g., a low gate voltage that is greater than, less than, or the same as voltage VGL, and that is less than voltage VGH). Transistor 608 may have a first source-drain terminal coupled to line 600, a second source-drain terminal coupled to carry signal output node 609, and a gate terminal coupled to node 615 and configured to receive signal QF. Transistor 608 may have a first source-drain terminal coupled to carry signal output node (or terminal) 609, a second source-drain terminal coupled to line 611, and a gate terminal configured to receive signal QB. The output carry signal CROUT may be provided from node 609 to another gate driver (e.g., a subsequent gate driver in the chain of gate drivers, in which driver 506 belongs, such as a gate driver for a first succeeding pixel row, a gate driver for a second succeeding pixel row, etc.).

To provide control signal QF at node 615 coupled to the gate terminals of transistors 602 and 608, driver 506 may include transistors 612, 614, and 616, and a capacitor 618. In particular, transistor 612 may have a first source-drain terminal coupled to a carry signal input terminal that provides input carry signal CRIN, a second source-drain terminal coupled to transistor 614 (and node 615 therethrough), and a gate terminal coupled to a first clock input terminal that provides input clock signal CLK1. Transistor 614 may have a first source-drain terminal coupled to the second source-drain terminal of transistor 612, a second source-drain terminal coupled to node 615 providing signal QF, and a gate terminal coupled to line 600 (e.g., a supply voltage terminal) supplying high gate voltage VGH.

Transistors 612 and 614 may be coupled along a first path (or branch) to node 615. A second path (or branch), along which transistor 616 and capacitor 618 are coupled, may be coupled to node 615. In particular, transistor 616 may have a first source-drain terminal coupled to a second clock input terminal that provides input clock signal CLK2, a second source-drain terminal, and a gate terminal coupled to node 615. Capacitor 618 may be coupled between (e.g., have respective terminals coupled to) the second source-drain terminal and the gate terminal of transistor 616.

Accordingly, signal QF may be generated based on clock signals CLK1 and CLK2, and input carry signal CRIN to provide the desired rising edge behavior of the driver output signal OUT and of the output carry signal CROUT by controlling transistors 602 and 608, respectively. In illustrative configurations described herein as an example, to generate signal QF, input carry signal CRIN may be sampled using transistor 612 (sometimes referred to as a sampling transistor) when clock signal CLK1 is asserted (e.g., pulsed high) and transistor T4 connects transistor 612 to node 615. During suitable time periods (e.g., when clock signal CLK2 is asserted or pulsed high), signal QF may be boosted by transistor 616 and capacitor 618 to exhibit an elevated boost voltage level. Signal QB may generated based on clock signal CLK1, clock signal CLK2, and/or input carry signal CRIN to provide the desired falling edge behavior of the driver output signal OUT and of the output carry signal CROUT by controlling transistors 604 and 610, respectively.

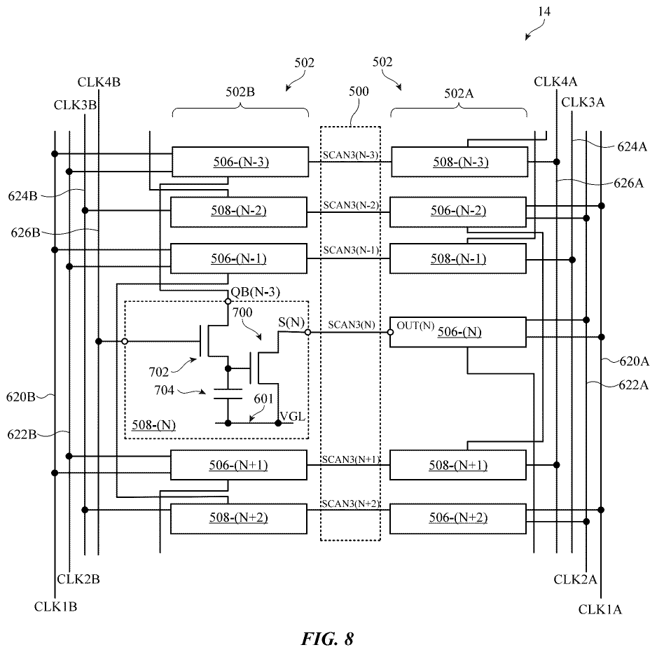

As described in connection with FIG. 6, an anode reset control signal driver (e.g., a driver 506 of FIG. 7) and a corresponding pull-down circuit may be used for each row of pixels 22 to provide the desired anode reset operations that mitigate (e.g., reduce) display and touch interference effects and provide display luminance uniformity across active area 500 (e.g., reduce luminance variation between even and odd pixels rows) while reducing display border widths. FIG. 8 is a diagram of an illustrative portion of gate driver circuitry including per-row anode reset control signal driver circuitry and per-row pull-down circuitry in an interlaced configuration.

As shown in FIG. 8, gate driver circuitry 502 (FIG. 6) may include circuitry portions 502A and 502B on opposing sides of active area 500 (e.g., the array of pixels 22). Gate driver circuitry 502 may include a gate driver 506 (FIG. 7) for each row of pixels 22 in active area 500. In particular, gate driver circuitry 502 may include a gate driver 506-(N) (e.g., an instance of driver 506 in FIG. 7) that supplies control signal SCAN3(N) for anode reset transistors Tar of pixels 22 in row N, a gate driver 506-(N−1) (e.g., an instance of driver 506 in FIG. 7) that supplies control signal SCAN3(N−1) for anode reset transistors Tar of pixels 22 in row (N−1), a gate driver 506-(N−1) (e.g., an instance of driver 506 in FIG. 7) that supplies control signal SCAN3(N−1) for anode reset transistors Tar of pixels 22 in row (N−1), a gate driver 506-(N−2) (e.g., an instance of driver 506 in FIG. 7) that supplies control signal SCAN3(N−2) for anode reset transistors Tar of pixels 22 in row (N−2), a gate driver 506-(N−3) (e.g., an instance of driver 506 in FIG. 7) that supplies control signal SCAN3(N−3) for anode reset transistors Tar of pixels 22 in row (N−3), etc., and may include a gate driver 506-(N+1) (e.g., an instance of driver 506 in FIG. 7) that supplies control signal SCAN3(N+1) for anode reset transistors Tar of pixels 22 in row (N+1), a gate driver 506-(N+2) (e.g., an instance of driver 506 in FIG. 7) that supplies control signal SCAN3(N+2) for anode reset transistors Tar of pixels 22 in row (N+2), etc.

These gate drivers 506 of gate driver circuitry 502 may be split between portions 502A and 502B on opposing sides of active area 500. In the example of FIG. 8, gate driver circuitry portion 502A may include gate drivers 506-(N), 506-(N−2), 506-(N−4), etc., and 506-(N+2), 506-(N+4), etc., for every other pixel row (e.g., for even rows). Gate driver circuitry portion 502B may include gate drivers 506-(N−1), 506-(N−3), etc., and 506-(N+1), 506-(N+3), etc., for every other pixel row (e.g., for odd rows).

Different sets of clock signals may be provided to drivers 506 in circuitry portion 502A and to drivers 506 in circuitry portion 502B. In particular, drivers 506 in circuitry portion 502A may be configured to receive clock signal CLK1A and clock signal CLK2A (e.g., respectively conveyed on corresponding signal paths 620A and 622A). In other words, transistors 612 and 616 of drivers 506 in circuitry portion 502A may receive clock signal CLK1A (as signal CLK1 in FIG. 7) and clock signal CLK2A (as signal CLK2 in FIG. 7), respectively. Drivers 506 in circuitry portion 502B may be configured to receive clock signal CLK1B and clock signal CLK2B (e.g., respectively conveyed on corresponding signal paths 620B and 622B). In other words, transistors 612 and 616 of drivers 506 in circuitry portion 502B may receive clock signal CLK1B (as signal CLK1 in FIG. 7) and clock signal CLK2B (as signal CLK2 in FIG. 7), respectively.

Gate driver circuitry 502 may include a pull-down circuit 508 for each row of pixels 22 in active area 500. In particular, gate driver circuitry 502 may include a pull-down circuit 508-(N) (e.g., an instance of pull-down circuit 508) coupled to the row line conveying control signal SCAN3(N) for anode reset transistors Tar of pixels 22 in row N and coupled to the corresponding driver 506-(N) via the row line, a pull-down circuit 508-(N−1) (e.g., an instance of pull-down circuit 508) coupled to the row line conveying control signal SCAN3(N−1) for anode reset transistors Tar of pixels 22 in row (N−1) and coupled to the corresponding driver 506-(N−1) via the row line, a pull-down circuit 508-(N−2) (e.g., an instance of pull-down circuit 508) coupled to the row line conveying control signal SCAN3(N−2) for anode reset transistors Tar of pixels 22 in row (N−2) and coupled to the corresponding driver 506-(N−2) via the row line, a pull-down circuit 508-(N−3) (e.g., an instance of pull-down circuit 508) coupled to the row line conveying control signal SCAN3(N−3) for anode reset transistors Tar of pixels 22 in row (N−3) and coupled to the corresponding driver 506-(N−3) via the row line, etc., and may include a pull-down circuit 508-(N+1) (e.g., an instance of pull-down circuit 508) coupled to the row line conveying control signal SCAN3(N+1) for anode reset transistors Tar of pixels 22 in row (N+1) and coupled to the corresponding driver 506-(N+1) via the row line, a pull-down circuit 508-(N+2) (e.g., an instance of pull-down circuit 508) coupled to the row line conveying control signal SCAN3(N+2) for anode reset transistors Tar of pixels 22 in row (N+2) and coupled to the corresponding driver 506-(N+2) via the row line, etc.

These pull-down circuits 508 of gate driver circuitry 502 may be split between portions 502A and 502B on opposing sides of active area 500. In the example of FIG. 8, gate driver circuitry portion 502A may include pull-down circuits 508-(N−1), 508-(N−3), etc., and 508-(N+1), 508-(N+3), etc., for every other pixel row (e.g., for odd rows). Gate driver circuitry portion 502B may include pull-down circuits 508-(N), 508-(N−2), 508-(N−4), etc., and 508-(N+2), 508-(N+4), etc., for every other pixel row (e.g., for even rows).

The configuration of pull-down circuit 508 is illustrated in the example of FIG. 8 in connection with pull-down circuit 508-(N) for pixel row N. Other pull-down circuits 508 may be configured in analogous manners in connection with their respective pixel rows.

As shown in FIG. 8, each pull-down circuit 508 (e.g., exemplified using pull-down circuit 508-(N)) may include a pull-down transistor 700, a sampling transistor 702, and a storage capacitor 704. Transistor 700 may have a first source-drain terminal coupled to the gate line supplying the anode reset control signal SCAN3, a second source-drain terminal coupled to line 601 supplying low gate voltage VGL, and a gate terminal coupled to transistor 702 (or more specifically, a node between transistor 702 and capacitor 704). Transistor 702 may have a first source-drain terminal coupled to driver 506 for the third row preceding the row of the pull-down circuit 508 to receive signal QB from the coupled driver 506, a second-source drain terminal coupled to capacitor 704 and the gate terminal of transistor 700, and a gate terminal configured to receive a clock signal. Capacitor 704 may be coupled between (e.g., have respective terminals coupled to) the common node between transistors 700 and 702 and line 601.

When provided in pull-down circuit 508-N, the first source-drain terminal of transistor 702 may be coupled to driver 506-(N−3) for row (N−3) to receive signal QB(N−3) used to control transistors 604 and 610 in driver 506-(N−3). The first source-drain terminals of transistors 702 of other pull-down circuits 508 (in both portions 502A and 502B) may similarly each receive the corresponding signal QB from its respective third preceding driver 506.

The clock signal received by the gate terminal of transistor 702 in each pull-down circuit 508 in portion 502A may be clock signal CLK3A or clock signal CLK4A. In particular, the gate terminal of transistor 702 in every other pull-down circuit 508 in portion 502A (e.g., in pull-down circuit 508 for every fifth pixel row such as pull-down circuit 508-(N−1), pull-down circuit 508-(N−5), etc., pull-down circuit 508-(N+3), pull-down circuit 508-(N+7), etc.) may be configured to receive clock signal CLK3A (e.g., provided on corresponding signal path 624A). The gate terminal of transistor 702 in the remaining every other pull-down circuit 508 in portion 502A (e.g., in pull-down circuit 508 for every fifth pixel row such as pull-down circuit 508-(N−3), pull-down circuit 508-(N−7), etc., pull-down circuit 508-(N+1), pull-down circuit 508-(N+5), etc.) may be configured to receive clock signal CLK4A (e.g., provided on corresponding signal path 626A).

The clock signal received by the gate terminal of transistor 702 in each pull-down circuit 508 in portion 502B may be clock signal CLK3B or clock signal CLK4B. In particular, the gate terminal of transistor 702 in every other pull-down circuit 508 in portion 502B (e.g., in pull-down circuit 508 for every fifth pixel row such as pull-down circuit 508-(N−2), pull-down circuit 508-(N−6), etc., pull-down circuit 508-(N+2), pull-down circuit 508-(N+6), etc.) may be configured to receive clock signal CLK3B (e.g., provided on corresponding signal path 624B).

The gate terminal of transistor 702 in the remaining every other pull-down circuit 508 in portion 502B (e.g., in pull-down circuit 508 for every fifth pixel row such as pull-down circuit 508-(N), pull-down circuit 508-(N−4), pull-down circuit 508-(N−8), etc., pull-down circuit 508-(N+4), pull-down circuit 508-(N+8), etc.) may be configured to receive clock signal CLK4B (e.g., provided on corresponding signal path 626B).

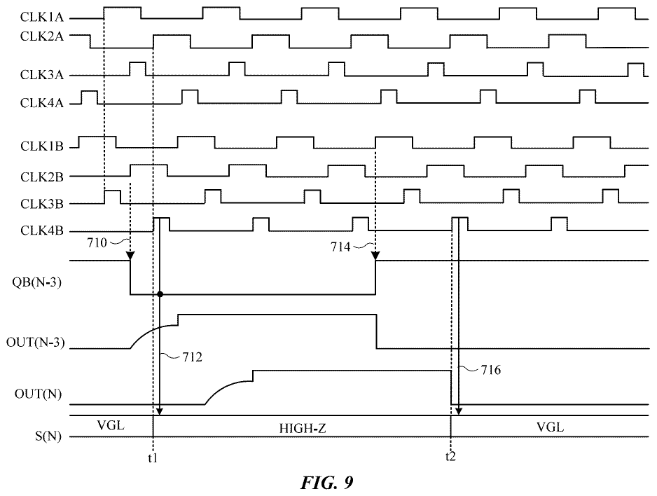

Illustrative operations of gate driver circuitry for a given pixel row are described using the timing diagram of FIG. 9 in connection with illustrative driver 506-(N) in portion 502A and illustrative pull-down circuit 508-(N) in portion 502B coupled to driver 506-(N) via the corresponding gate line supplying anode reset control signal SCAN3(N). As shown in FIG. 9, pull-down circuit 508-(N) may provide (e.g., exhibit) two states as output S(N) for the gate line coupled to driver 506-(N). In particular, between time t1 and time t2, pull-down circuit 508-(N) may be configured to exhibit a high impedance state (e.g., with pull-down transistor 700 therein being deactivated) such that output S(N) is not pulled-down or driven. During this time period, the anode reset control signal on the gate line is controlled and driven by driver 506-(N), which provides signal OUT(N) as anode reset control signal SCAN3(N) on the gate line (e.g., signal SCAN3(N) may exhibit the waveform of signal OUT(N) provided from right-side driver 506-(N) between time t1 and time t2). At and after time t2, pull-down circuit 508-(N) may be configured to drive output S(N) (e.g., from the left-side of the gate line) to low gate voltage VGL (e.g., with pull-down transistor 700 therein being activated to connect the left-side of the gate line to supply voltage line 601). At and after time t2, driver 506-(N) may also be configured to drive output Out(N) (e.g., from the right-side of the gate line) to low gate voltage VGL (e.g., transistor 604 therein being activated to connect the right-side of the gate line to supply voltage line 601).

While the operations of a pair of driver 506 and pull-down circuit 508 in connection with a single pixel row such as row N are described in connection with FIG. 9, analogous operations may occur for each pair of driver 506 and pull-down circuit 508 for each of the pixel rows. Accordingly, by providing driving from both sides of the gate line for each row, the falling edge behavior of anode reset control signals across all rows (e.g., across even and odd rows) may be more uniform, thereby providing more uniform display luminance and mitigating the issues described in connection with FIG. 6.

As further illustrated by the example of FIG. 9, prior to time t1, a rising edge of clock signal CLK2B may cause a falling edge of signal QB(N−3) in driver 506-(N−3) (e.g., a state change from a high voltage state to a low voltage state) as indicated by dashed arrow 710. At time t1, clock CLK4B may be pulsed high to activate sampling transistor 702 of pull-down circuit 508-(N), thereby sampling the low voltage state of signal QB(N−3) at time t1, as indicated by arrow 712. The sampled low voltage state of signal QB(N−3) may be stored (by capacitor 704) at the gate terminal of transistor 700 to deactivate transistor 700 to place pull-down circuit 508-(N) in a high impedance state beginning at time t1.

After time t1 and prior to time t2, a rising edge of clock signal CLK 1B may cause a rising edge of signal QB(N−3) in driver 506-(N−3) (e.g., a state change from the low voltage state to the high voltage state) as indicated by dashed arrow 714. The time period between this rising edge of signal QB(N−3) and the above-mentioned prior falling edge of signal QB(N−3) may provide the time window during which driver 506-(N−3) drives the anode reset control signal (e.g., controlled by driver output signal OUT(N−3) shown in FIG. 9) for pixel row (N−3) to a high gate voltage (e.g., voltage VGH). At time t2, clock CLK4B may be pulsed high to activate sampling transistor 702 of pull-down circuit 508-(N), thereby sampling the high voltage state of signal QB(N−3) at time t2, as indicated by arrow 716. The sampled high voltage state of signal QB(N−3) may be stored (by capacitor 704) at the gate terminal of transistor 700 to activate transistor 700 to drive (e.g., pull-down) the gate line (on which signal SCAN3(N) is provided) to a low gate voltage (e.g., voltage VGL) beginning at time t2.

In illustrative configurations sometimes described as examples in connection with FIG. 9, rising edges of clock signal CLK1A may be aligned with (e.g., occur at the same time as) rising edges of clock signal CLK3B, and rising edges of clock signal CLK2A may be aligned with (e.g., occur at the same time as) rising edges of clock signal CLK4B. Similarly, rising edges of clock signal CLK3A may be aligned with (e.g., occur at the same time as) rising edges of clock signal CLK2B, and rising edges of clock signal CLK4A may be aligned with (e.g., occur at the same time as) rising edges of clock signal CLK1B. If desired, to reduce the number of clock signals, clock signals 1B and 3B may be consolidated into a single clock signal and clock signals 2B and 4B may be consolidated into a single clock signal. Similarly, if desired, clock signals 1A and 3A may be consolidated into a single clock signal and clock signals 2A and 4A may be consolidated into a single clock signal.

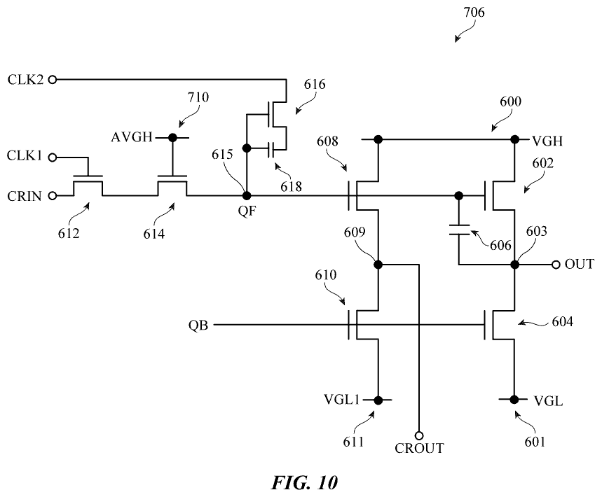

In the illustrative configuration of driver 506 in FIG. 7, transistor 614 has a gate terminal configured to high gate voltage VGH, which is the same voltage provided to the first source-drain terminals of transistors 602 and 608 (e.g., using the same power supply line 600). To further mitigate display and touch interference issues (e.g., as described in connection with FIG. 5A), among other advantages, gate driver circuitry (e.g., driver circuitry 502 in FIG. 6 or FIG. 8, gate driver circuitry 34 in FIG. 2, etc.) for supplying anode reset control signals may include gate drivers of the same type as gate driver 706 in FIG. 10.

As shown in FIG. 10, transistor 614 of gate driver 706 may have a gate terminal configured to receive a supply voltage signal AVGH that is distinct from voltage VGH. Voltage signal AVGH may provide a fixed voltage level (e.g., a direct current voltage) that is different than voltage VGH. In some illustrative configurations described herein as an example, voltage signal AVGH may provide different supply voltage levels during different time periods (e.g., is a variable or adjustable supply voltage signal). In particular, signal path 710 conveying voltage signal AVGH may be coupled to the gate terminal of transistor 614 to supply voltage signal AVGH. The other components of gate driver 706 and the configurations of the other components may be the same as gate driver 506 in FIG. 7.

The voltage (e.g., a direct current voltage) supplied to the gate terminal of transistor 614 may at least partly determine the knee voltage during the transition from low gate voltage VGL to high gate voltage VGH (e.g., the rising edge characteristics) of the driver output signal OUT (e.g., anode reset control signal SCAN3). The knee voltage may be a transitional voltage (level) that the driver output OUT reaches (when rising from voltage VGL) and levels off at prior to the driver output OUT being further boosted (e.g., using transistor 616 and capacitor 618) to reach voltage VGH. The knee voltage level may determine how quickly the driver output voltage rises, and in turn, determine the peak level of anode reset discharge current (e.g., described in connection with FIG. 5A). Accordingly, adjusting the knee voltage level (e.g., by lowering the voltage supplied to the gate terminal of transistor 614 from voltage VGH) may reduce peak anode reset discharge current, thereby mitigating interference between display circuitry and touch sensor circuitry.

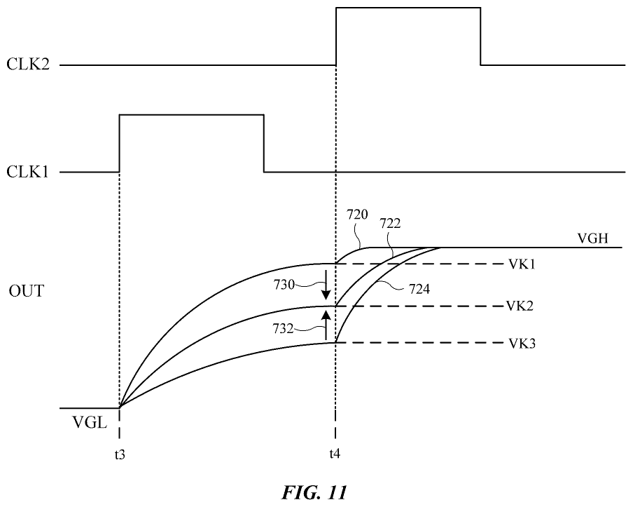

FIG. 11 is an illustrative timing diagram of signals during the operation of a gate driver such as gate driver 706 in FIG. 10. Three illustrative waveforms for driver output OUT based on three corresponding operating scenarios are shown in FIG. 11.

For all three scenarios, prior to time t3, driver output OUT may be at the voltage level of voltage VGL supplied by line 601 in FIG. 10 (e.g., signal QB is pulsed high to activate transistors 604 in FIG. 10). At time t3, clock signal CLK1 may be pulsed high to activate transistor 612 and to use transistor 612 to sample the state of carry signal CRIN onto node 615 through transistor 614 controlled by signal AVGH. The sampled state on node 615 may activate transistor 602 to pull up the driver output OUT from voltage level VGL. Signal QB may be pulsed low at and after time t3 (e.g., to deactivate transistor 604).

Line 720 represents a first waveform in a first operating scenario for driver 706 (e.g., driver 506 in FIG. 7) when voltage VGH is supplied to the gate terminal of transistor 614. In this first scenario, driver output OUT may rise from voltage level VGL at time t3 to knee voltage level VK1 at time t4. Line 722 represents a second waveform in a second operating scenario for driver 706 when a voltage AVGH (e.g., a voltage less than voltage VGH) is supplied to the gate terminal of transistor 614. In this second scenario, driver output OUT may rise from voltage level VGL at time t3 to knee voltage level VK2 (less than voltage level VK1) at time t4.

Accordingly, as shown in FIG. 11, by providing a voltage AVGH different than (e.g., less than) voltage VGH to transistor 614, the output driver waveform may exhibit a smaller slew (or a slower slew rate) when reaching the knee voltage. In other words, the rising slope of line 722 between time t3 and time t4 may be more gradual than the rising slope of line 720 between time t3 and time t4. Consequently, peak anode reset discharge current, which is (positively) correlated to the slew rate (e.g., the steepness of the rising slope) of the driver output waveform, may be reduced when a voltage AVGH is used. Accordingly, it may be desired to use a voltage AVGH instead of voltage VGH to move from drive output exhibiting knee voltage VK1 to driver output exhibiting knee voltage VK2 (as indicated by arrow 730).

Over time, when a voltage AVGH less than voltage VGH is used, the knee voltage exhibited by driver output may be undesirably lowered over time (e.g., due to driver aging). For example, line 724 represents a third waveform in a third operating scenario for driver 706 in which driver aging effects are exhibited (e.g., after a fixed voltage AVGH has been supplied to the gate terminal of transistor 614 for a period of time) and in which driver output OUT undesirably exhibits knee voltage level VK3 at time t4. In particular, low knee voltage level VK3 may be undesired because, while a slower slew rate to the knee voltage is exhibited between time t3 and time t4, an undesirably high slew rate to voltage VGH is exhibited after time t4 (e.g., thereby introducing elevated peak anode reset discharge current). To mitigate the aging effects in this third scenario, a calibrated voltage AVGH (e.g., different from an initial voltage AVGH supplied in the second scenario) may be supplied to the gate terminal of transistor 614 such that driver output OUT may rise from voltage level VGL at time t3 to knee voltage level VK2 (instead of lower knee voltage level VK3) at time t4, as indicated by arrow 732.

For all three scenarios, at time t4, driver output OUT may be at the knee voltage level. At time t4, clock signal CLK2 may be pulsed high to use transistor 616 and capacitor 618 to boost signal QF (e.g., to a boosted voltage level above the voltage level exhibited between time t3 and time t4). The boosted voltage on node 615 may boost the driving of transistor 602 to pull up the driver output OUT to voltage level VGH.

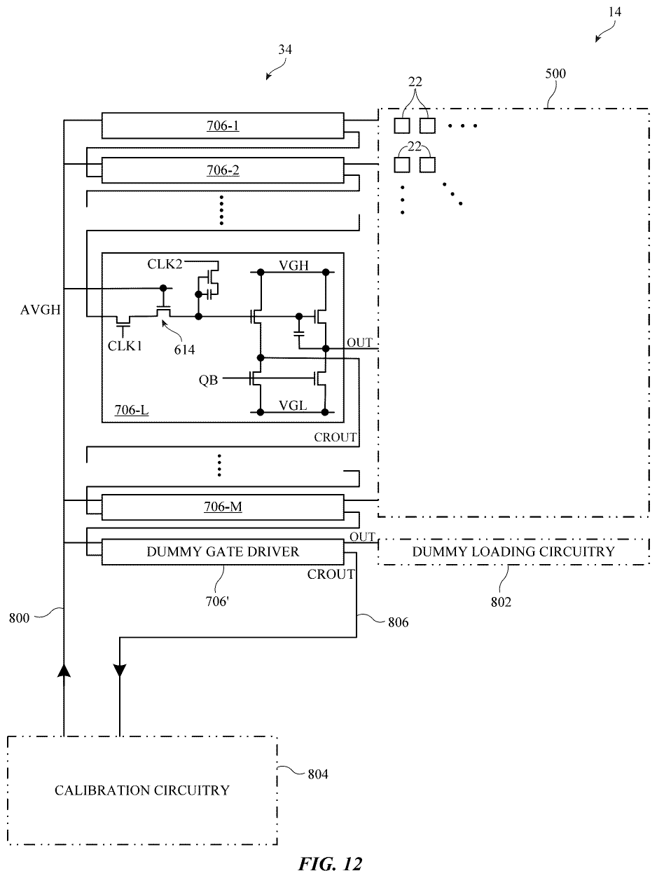

FIG. 12 is a diagram of illustrative gate driver circuitry including gate drivers of the type shown in FIG. 10 (e.g., a chain of gate drivers 706) and a dummy driver circuit (e.g., a dummy gate driver 706 in the chain) for calibrating (e.g., adjusting) supply voltage signal AVGH (e.g., described in connection with FIG. 11). In particular, as shown in FIG. 12, display gate driver circuitry 34 may include a chain of gate drivers 706-1, 706-2, . . . , 706-L, . . . , 706-M, including a dummy gate driver 706′. In the illustrative example of FIG. 12, gate drivers 706 in the chain (excluding dummy driver 706′) may each be coupled to a corresponding row of pixels 22 via a corresponding gate line. Dummy driver 706′ may be coupled to dummy loading circuitry 802 via a corresponding gate line. Dummy loading circuitry 802 may include a row of dummy pixels and/or other circuitry that mimic the loading (e.g., the resistive, capacitive, etc., loading effects) of an actual pixel row.

Each gate driver in the chain (including dummy gate driver 706′) may be implemented using an instance of gate driver 706 in FIG. 10. Accordingly, each gate driver in the chain (including dummy gate driver 706′) may receive clock signal CLK 1 (at a respective transistor 612) from a first clock signal path (coupled to the gate driver), may receive clock signal CLK2 (at a respective transistor 616) from a second clock signal path (coupled to the gate driver), and may receive an adjustable (direct current) supply voltage signal AVGH (at a respective transistor 614) from signal path 800 (coupled to the gate driver). Each gate driver in the chain (including dummy driver 706′) may also receive an input carry signal CRIN from a preceding gate driver in the chain (or from a driver circuit, when the given gate driver is the first in the chain) and may provide an output carry signal CROUT to a succeeding gate driver (or to other circuitry, when the given gate driver is the last in the chain).

Based on the set of corresponding input signals, each gate driver in the chain may provide its respective driver output signal OUT to the corresponding gate line. Configurations in which the driver output signal OUT is an anode reset control signal received by transistors Tar in pixels 22 of the row coupled to the gate line are described herein as an example.

As described in connection with FIG. 11, it may be desirable to calibrate voltage signal AVGH to exhibit different voltage levels (e.g., such that driver output OUT exhibits one or more desired knee voltage levels, even as driver circuitry ages over time). Accordingly, as shown in FIG. 12, the output carry signal CROUT provided by dummy gate driver 706′ may be conveyed on signal path 806 to calibration circuitry 804. Based on signal CROUT, calibration circuitry 804 may calibrate signal AVGH being output (e.g., by adjusting the direct current voltage level exhibited by signal AVGH). In particular, signal CROUT may have the same waveform as (or at least be similar to) signal OUT (provided by dummy gate driver 706′) and may be indicative of signal OUT of dummy gate driver 706′ (and consequently output signals OUT of other drivers 706) exhibiting a knee voltage level that is outside of an acceptable range (e.g., not exhibiting the desired knee voltage level). Based on this indication, calibration circuitry 804 may adjust the direct current voltage level of signal AVGH to return the knee voltage level to within the acceptable range or value. Doing so may preserve a low level of interference between the display circuitry and the touch sensor circuitry (initially obtained using an initial voltage level for signal AVGH) even as driver circuitry ages.

In some illustrative configurations, signal CROUT on path 806 may be passed through an analog-to-digital converter. The output of the analog-to-digital converter, based on input signal CROUT, may include a degradation (voltage) value indicative of a degree from which the actual knee voltage level is deviating or degrading from the desired knee voltage level.

Calibration circuitry 804 may map the degradation (voltage) value to a corresponding boost (voltage) value, e.g., by using a lookup table, by calculating the boost value using the degradation value, etc. The boost value may be provided by calibration circuitry 804 to power management circuitry (e.g., a power management integrated circuit) as input such that the power management circuitry may adjust signal AVGH provided on path 800 using the boost value (e.g., adding the boost voltage value to the initial voltage level for signal AVGH).

While a closed-loop or feedback scheme is described in connection with the example of FIG. 12 to be used to adjust signal AVGH, this example is merely illustrative. If desired, calibrated values may be generated during testing (e.g., device factory testing) and the appropriate calibrated values may be stored and used (e.g., by calibration circuitry 804) to supply signal AVGH at desired voltage levels (e.g., instead of using output from dummy gate driver(s)).

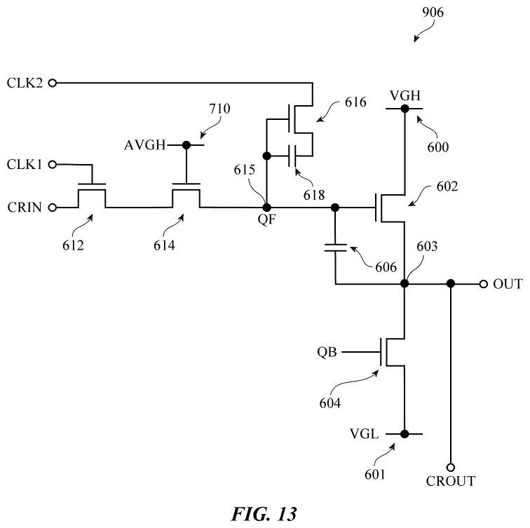

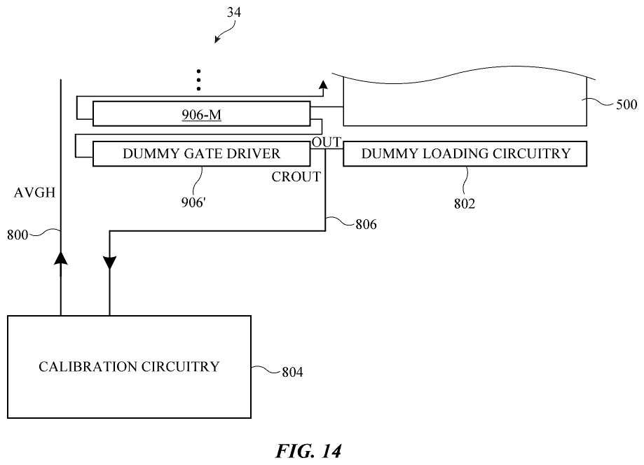

The configuration of gate driver 706 in FIG. 10 is merely illustrative. If desired, other types of gate drivers may be used in gate driver circuitry (e.g., gate driver circuitry 34). As an example, some transistors may be omitted from gate driver 706. As shown in the example of FIG. 13, relative to gate driver 706 in FIG. 10, transistors 608 and 610 may be omitted from gate driver 906 in FIG. 13. Accordingly, gate driver 906 may provide an output carry signal CROUT from the same node 603 that provides driver output signal OUT. Accordingly, as shown in the example of FIG. 14, when a chain of gate drivers of the type shown in FIG. 13 (e.g., gate drivers 906) are used in driver circuitry 34 (instead of gate drivers 706 as described in connection with FIG. 12), driver output OUT (i.e., the same as carry output signal CROUT) may be received by calibration circuitry 804 and used to generate the adjustable voltage level of signal AVGH.

In the example of FIG. 14, path 806 is coupled to dummy gate driver 906′ and configured to convey output carry signal CROUT (i.e., the same as driver output signal OUT) of dummy gate driver 906′ to calibration circuitry 804 (e.g., to facilitate the adjustment of the supply voltage signal on path 800). However, this example is merely illustrative.

If desired, path 806 (and/or other additional input paths coupled to calibration circuitry 804) may be coupled to other locations (in addition to or instead of the output terminal of dummy gate driver 906′) to provide calibration circuitry 804 with suitable input(s) based on which the supply voltage signal on path 800 can be adjusted. As an example, path 806 may be coupled to another gate driver 906 in the chain of gate drivers in circuitry 34 (e.g., active gate driver 906-M) and may provide output carry signal CROUT (or the driver output signal OUT) from the other gate driver (e.g., gate driver 906-M) to calibration circuitry 804. As another example, path 806 may be coupled to a node or terminal within active area 500 (e.g., coupled along a part of the gate line driven by gate driver 906-M that is between pixels 22, coupled to a pixel input or output terminal, etc.) and may provide a varied version of the driver output signal OUT output by a gate driver, as the signal OUT is carried across active area 500, to calibration circuitry 804.

While these examples of the various implementation of path 806 (e.g., coupled to different locations of driver circuitry 34 and/or within active area 500) are described in connection with FIG. 14, this is merely illustrative. If desired, path 806 (and/or other input paths of calibration circuitry 804) of FIG. 12 may similarly couple calibration circuitry 804 to any corresponding location (e.g., coupled to an output terminal of gate driver 706-M or another gate driver in circuitry 34 of FIG. 12, coupled to a location within active area 500 of FIG. 12, etc.) to provide calibration circuitry 804 with any suitable version of a carry signal, any suitable version of a gate driver output signal, and/or any other suitable signal (e.g., that serves as an indication of gate driver output signal knee voltage and/or gate driver output signal rising edge behavior).

Configurations in which transistors of gate drivers and of other gate driver circuitry (e.g., as described in connection with FIGS. 6-14) are implemented using n-type transistors (e.g., n-channel transistors such as n-channel metal-oxide-semiconductor field-effect transistors) are described herein as illustrative examples. If desired, one or more (e.g., all) of the transistors in gate drivers and/or other gate driver circuitry (e.g., as described in connection with FIGS. 6-14) may be implemented using p-type transistors (e.g., p-channel transistors such as p-channel metal-oxide-semiconductor field-effect transistors), and corresponding components that operate with these p-type transistors may be adapted as appropriate (e.g., high and low supply voltage lines may be switched).

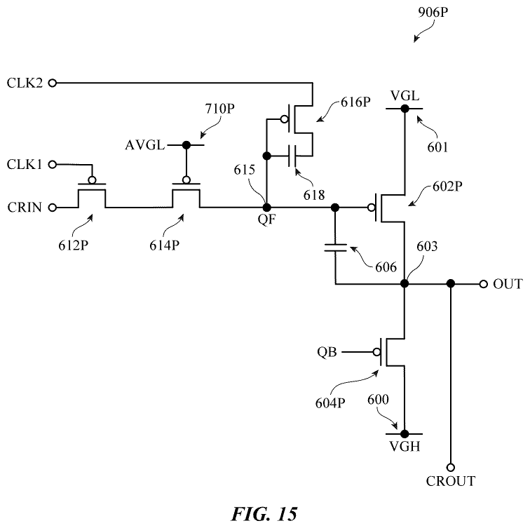

As an example, FIG. 15 shows an illustrative gate driver 906P that includes p-type transistors (e.g., may be a version of gate driver 906 in FIG. 13 when implemented using p-type transistors). In the example of FIG. 15, gate driver 906P may include (p-type) transistors 602P and 604P coupled in series between power supply (voltage) line 601 supplying low gate voltage VGL and power supply (voltage) line 600 supplying high gate voltage VGH (greater than voltage VGL). Transistor 602P may have a first source-drain terminal coupled to line 601, a second source-drain terminal coupled to driver output node (or terminal) 603, and a gate terminal coupled to node 615 and configured to receive signal QF. Driver 906P may include capacitor 606 having a first terminal coupled to the gate terminal of transistor 602P and a second terminal coupled to node 603 (e.g., to the second source-drain terminal of transistor 602P). Transistor 604P may have a first source-drain terminal coupled to driver output node 603, a second source-drain terminal coupled to line 600, and a gate terminal configured to receive signal QB. The driver output signal OUT, which is SCAN3 when driver 906P implements an anode reset control signal driver, may be provided from node 603 to any transistors Tar of pixels 22 coupled to driver 906P. In the example of FIG. 15, node 603 may also serve as the carry signal output node, providing output carry signal CROUT (the same as driver output signal OUT) to another gate driver (e.g., a subsequent gate driver in the chain of gate drivers, in which driver 906P belongs, such as a gate driver for a first succeeding pixel row, a gate driver for a second succeeding pixel row, etc.).

To provide control signal QF at node 615 coupled to the gate terminal of transistor 602P, driver 906P may include (p-type) transistors 612P, 614P, and 616P, and a capacitor 618. In particular, transistor 612P may have a first source-drain terminal coupled to a carry signal input terminal that provides input carry signal CRIN, a second source-drain terminal coupled to transistor 614P (and node 615 therethrough), and a gate terminal coupled to a first clock input terminal that provides input clock signal CLK1. Transistor 614P may have a first source-drain terminal coupled to the second source-drain terminal of transistor 612P, a second source-drain terminal coupled to node 615 providing signal QF, and a gate terminal. Transistors 612P and 614P may be coupled along a first path (or branch) to node 615. A second path (or branch), along which transistor 616P and capacitor 618 are coupled, may be coupled to node 615. In particular, transistor 616P may have a first source-drain terminal coupled to a second clock input terminal that provides input clock signal CLK2, a second source-drain terminal, and a gate terminal coupled to node 615. Capacitor 618 may be coupled between (e.g., have respective terminals coupled to) the second source-drain terminal and the gate terminal of transistor 616P.

As similarly described in connection with transistor 614 in gate driver 706 of FIG. 10 and in gate driver 906 of FIG. 13, the gate terminal of transistor 614P may be supplied with an adjustable supply voltage signal (e.g., voltage signal AVGH in FIGS. 10 and 13). However, given the p-type transistors used to implement driver 906P in FIG. 15, the gate terminal of transistor 614P may be coupled to line 710P (e.g., a supply voltage terminal) supplying a (variable or adjustable) low gate supply voltage AVGL. In some configurations, voltage AVGL may be a supply voltage at a fixed voltage level (e.g., a direct current voltage) that is different than voltage VGL (supplied by line 601). In some illustrative configurations described herein as an example, voltage signal AVGL may provide different supply voltage levels during different time periods (e.g., is a variable or adjustable supply voltage signal). This adjustable low gate supply voltage signal AVGL may similarly provide knee voltage control in the rising edges of the driver output OUT and may consequently be used to reduce peak anode reset discharge current, thereby mitigating interference between display circuitry and touch sensor circuitry (e.g., as similarly described in connection with FIGS. 10-14). The calibration of the variable supply voltage (e.g., using the output of a corresponding dummy driver, to mitigate aging effects, etc.) as described in connection with FIGS. 12 and 14 may similarly be applied to driver circuitry that include a chain of drivers 906P (e.g., driver circuitry 34 in FIG. 14, when including a chain of drivers 906P instead of drivers 906).

While a p-type transistor implementation of gate driver 906 in FIGS. 13 and 14 is shown herein (e.g., in FIG. 15), this is merely illustrative. Transistors of other gate drivers and/or other gate driver circuitry described herein (e.g., gate drivers 706 of FIGS. 10 and 12, gate drivers 506 of FIGS. 7 and 8, pull-down circuits 508 in FIG. 8, etc.) may similarly be implemented using p-type transistors.

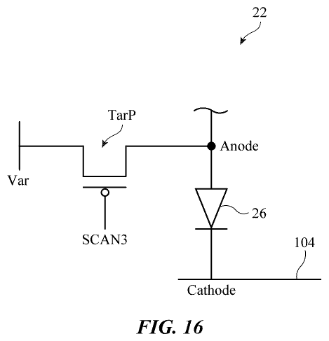

In illustrative configurations where a gate driver (e.g., gate driver 906P in FIG. 15) includes p-type transistors, the corresponding transistor(s) (e.g., within pixels in one or more rows of a pixels array) controlled by the gate driver may similarly be implemented as p-type transistor(s). As shown in FIG. 16, pixel 22 (e.g., of FIG. 5A) may include p-type anode reset transistor TarP (instead of transistor Tar shown in FIG. 5A). Transistor TarP may receive the driver output signal OUT from (p-type) gate driver 906P in FIG. 15 (or from other gate drivers containing p-type transistors) as anode reset control signal SCAN3. Other components of pixel 22 (FIG. 5A) are omitted from FIG. 16 in order to not unnecessarily obscure the embodiments in connection with FIG. 16 but may be implemented in a similar manner as described in connection with FIG. 5A.

The foregoing is merely illustrative and various modifications can be made to the described embodiments. The foregoing embodiments may be implemented individually or in any combination.

1. A display comprising:
an array of pixels each comprising a light-emitting diode and an anode reset transistor coupled to the light-emitting diode; and
gate driver circuitry configured to provide control signals for the anode reset transistors of the array of pixels and including:
a plurality of gate drivers coupled to the anode reset transistors of pixels in respective rows of the array of pixels via a corresponding plurality of gate lines; and
a plurality of pull-down circuits each coupled to a corresponding gate line in the plurality of gate lines.

2. The display defined in claim 1, wherein the plurality of gate drivers include first and second sets of gate drivers on first and second opposing sides of the array of pixels, respectively.

3. The display defined in claim 2, wherein the plurality of pull-down circuits include first and second sets of pull-down circuits on the first and second opposing sides of the array of pixels, respectively.

4. The display defined in claim 3, wherein the plurality of gate drivers and the plurality of pull-down circuits are arranged in an interlaced configuration.

5. The display defined in claim 1, wherein a given pull-down circuit of the plurality pull-down circuits comprises a pull-down transistor that couples a given gate line of the plurality of gate lines to a power supply line and comprises a capacitor coupled between a gate terminal of the pull-down transistor and the power supply line.

6. The display defined in claim 5, wherein the given pull-down circuit comprises a sampling transistor having a gate terminal configured to receive a clock signal, having a first source-drain terminal coupled to a given gate driver of the plurality of gate drivers, and having a second source-drain terminal coupled to the gate terminal of the pull-down transistor.

7. The display defined in claim 6, wherein the given gate driver includes:
first and second transistors coupled in series between the power supply line and an additional power supply line; and
a capacitor coupled between a gate terminal of the first transistor and a source-drain terminal of the first transistor, wherein the source-drain terminal of the first transistor is configured to provide a driver output signal and wherein the first source-drain terminal of the sampling transistor is configured to receive a control signal received by a gate terminal of the second transistor of the given gate driver.

8. The display defined in claim 6, wherein the given pull-down circuit is coupled to a given row of pixels in the array of pixels and wherein the given gate driver is coupled to a third preceding row of pixels in the array of pixels relative to the given row of pixels.

9. The display defined in claim 6, wherein the plurality of pull-down circuits comprises an additional pull-down circuit with a sampling transistor having a gate terminal configured to receive an additional clock signal.

10. The display defined in claim 5, wherein a given gate driver of the plurality of gate drivers is coupled to the given gate line and wherein the given pull-down circuit is configured to exhibit a first state during which the given gate driver drives an anode reset control signal on the given gate line to a high voltage and is configured to exhibit a second state during which the given gate driver drives the anode reset control signal on the given gate line to a low voltage.

11. Display driver circuitry comprising:
a chain of gate drivers, each gate driver comprising:
first and second supply voltage lines;
first and second transistors coupled in series between the first and second power supply lines;
a capacitor coupled between a gate terminal of the first transistor and a source-drain terminal of the first transistor, wherein the source-drain terminal is configured to provide a driver output signal; and
a third transistor having a source-drain terminal coupled to the gate terminal of the first transistor and having a gate terminal configured to receive an adjustable supply voltage signal.

12. The display driver circuitry defined in claim 11, wherein each gate driver in the chain of gate drivers comprises a fourth transistor having a first source-drain terminal configured to a receive an input carry signal and a second source-drain terminal coupled to the third transistor, and a gate terminal configured to receive a first clock signal.

13. The display driver circuitry defined in claim 12, wherein each gate driver in the chain of gate drivers comprises:
a fifth transistor having a first source-drain terminal configured to receive a second clock signal, a second source-drain terminal, and a gate terminal coupled to the source-drain terminal of the third transistor, and
an additional capacitor coupled between the first source drain terminal of the fifth transistor and the gate terminal of the fifth transistor.

14. The display driver circuitry defined in claim 11, wherein each gate driver in the chain of gate drivers comprises:
fourth and fifth transistors coupled in series between the first power supply line and a third power supply line, wherein the first and fourth transistors are configured to receive a first control signal, wherein the second and fifth transistors are configured to receive a second control signal, and wherein a common node between the fourth and fifth transistors is configured to provide an output carry signal.

15. The display driver circuitry defined in claim 11, wherein the source-drain terminal of the first transistor is configured to provide an output carry signal.

16. The display driver circuitry defined in claim 11, wherein the driver output signal is a control signal for performing an anode reset operation for light-emitting diodes of display pixels.

17. Display circuitry comprising:
a light-emitting diode;
a drive transistor coupled in series with the light-emitting diode;
a storage capacitor coupled to a gate terminal of the drive transistor;
an anode reset transistor having a gate terminal and configured to reset an anode of the light-emitting diode based on a control signal received at the gate terminal, wherein the light-emitting diode comprises a cathode that is electrically coupled to one or more touch sensor electrodes; and
a gate driver configured to receive an adjustable supply voltage signal and provide the control signal to the gate terminal of the anode reset transistor, wherein the provided control signal exhibits a knee voltage that is adjustable based on the received adjustable supply voltage signal.

18. The display circuitry defined in claim 17, wherein the gate driver is configured to receive first and second clock signals and wherein the provided control signal exhibits the knee voltage after the first clock signal is pulsed high and when the second clock signal is pulsed high.

19. The display circuitry defined in claim 17 further comprising:
calibration circuitry coupled to the gate driver and configured to:
receive an input signal indicative of the knee voltage exhibited by the control signal, and
adjust the adjustable supply voltage signal to exhibit different voltages based on the input signal.

20. The display circuitry defined in claim 19 further comprising:
a dummy gate driver coupled to the calibration circuitry and configured to provide an output signal, wherein the input signal received by the calibration circuitry is obtained from the output signal provided by the dummy gate driver.
